(19) United States
(12) Patent Application Publication
(10) Pub. No.: US 2026/0049263 A1
(43) Pub. Date: Feb. 19, 2026

(54) CLEANING COMPOSITION AND ASSOCIATED SPRAY AND METHOD

(71) Applicants: Raffi NALBANDIAN, Toronto (CA); Armin NALBANDIAN, North York (CA)

(72) Inventors: Raffi NALBANDIAN, Toronto (CA); Armin NALBANDIAN, North York (CA)

(21) Appl. No.: 19/300,721

(22) Filed: Aug. 15, 2025

Related U.S. Application Data
(60) Provisional application No. 63/683,365, filed on Aug. 15, 2024.
(60) Provisional application No. 63/742,576, filed on Jan. 7, 2025.

(51) Int. Cl. C11D 7/50; B65D 83/14; C11D 7/26; C11D 17/00

(52) U.S. Cl. CPC C11D 7/5022; B65D 83/14; C11D 7/266; C11D 17/0043

(57) ABSTRACT

A cleaning composition may include about 20 wt % to about 90 wt % dimethyl carbonate; 0 wt % to about 40 wt % methyl acetate and/or t-butyl acetate; and 0 wt % to about 10 wt % of one or more hydrocarbons of general formula (I): CₙH₂ₙ₊ₓ (I); wherein n is in a range of 5 to 8; and wherein x is 0 or 2. The cleaning composition may be a low VOC content brake cleaning composition useful for removing oil and particulate contamination from braking system components of vehicles such as automobiles.

This application claims the benefit of U.S. Provisional Application Nos. 63/683,365 filed Aug. 15, 2024, and 63/742,576 filed Jan. 7, 2025, the contents of which are incorporated by reference herein.

### BACKGROUND

The present disclosure relates to a cleaning composition, a spray containing the composition, and a cleaning method utilizing the composition. The spray may be an aerosol spray or a pump spray. Alternatively, the composition may be provided in a container that is not a spray container. Although the cleaning composition is particularly useful for cleaning brakes, its use is not limited thereto.

Oil and particulate contamination can negatively impact the performance of braking system components of vehicles such as automobiles. Brake cleaning compositions remove such contamination.

Volatile organic compounds (VOCs) form a large group of chemicals commonly found in both indoor and outdoor air. They can affect air quality. While some VOCs give off distinctive odors at higher levels, they may be present with no noticeable smell. Exposure to VOCs in indoor air may affect health, depending on which VOCs are present, the level of VOCs present, and exposure duration. Accordingly, many jurisdictions have laws and/or regulations concerning VOCs and there is great demand for low VOC products. Typical low VOC brake cleaning compositions contain high levels of acetone which can lead to a strong odor as well as damage to painted surfaces, plastics, etc.

It would be desirable to develop new cleaning compositions (e.g., brake cleaning compositions).

### BRIEF DESCRIPTION

Disclosed, in some embodiments, is a cleaning composition containing: about 20 wt % to about 90 wt % dimethyl carbonate; 0 wt % to about 40 wt % methyl acetate and/or t-butyl acetate; and 0 wt % to about 10 wt % of one or more hydrocarbons of general formula (I): CₙH₂ₙ₊ₓ (I), wherein n is in a range of 5 to 8; and wherein x is 0 or 2.

In some embodiments, the cleaning composition includes about 40 wt % to about 80 wt % dimethyl carbonate; about 10 wt % to about 40 wt % methyl acetate and/or t-butyl acetate; and about 0.1 wt % to about 10 wt % of one or more hydrocarbons of general formula (I).

In particular embodiments, the cleaning composition includes about 65 wt % to about 75 wt % dimethyl carbonate; about 15 wt % to about 25 wt % methyl acetate and/or t-butyl acetate; and about 1 wt % to about 10 wt % of one or more hydrocarbons of general formula (I).

In particular embodiments, x is 0. In other embodiments, x is 2.

An aerosol composition may include the above-described cleaning composition and a propellant.

Non-limiting examples of propellants include carbon dioxide, nitrogen, air, n-butane, isobutane, and propane.

An aerosol spray product may include a container defining an interior volume; the above-described aerosol composition within the interior volume; and a nozzle for spraying the aerosol composition.

Disclosed, in other embodiments, is a cleaning composition containing: about 20 wt % to about 90 wt % total of a carbonate ester and optionally a carboxylate ester; and 0 wt % to about 80 wt % total of one or more acetates and one or more additional hydrocarbons.

The carbonate ester may include a dialkyl carbonate.

In some embodiments, the carbonate ester includes dimethyl carbonate.

The one or more additional hydrocarbons may include an alkane.

In some embodiments, the ketone solvent is acetone.

The acetate may be present in an amount of about 0 wt % to about 40 wt % of the cleaning composition.

In some embodiments, the acetate is present in an amount of about 10 wt % to about 40 wt % of the cleaning composition.

In particular embodiments, the acetate is present in an amount of about 15 wt % to about 25 wt % of the brake cleaning composition.

The alkane may include one or more compounds of the formula C₂H₂ₙ₊ₓ, wherein n is from 5 to 8 and x is 0 or 2.

In some embodiments, the alkane is present in an amount of 0 wt % to about 10 wt % of the cleaning composition.

In particular embodiments, the alkane is present in an amount of about 1 wt % to about 10 wt % of the cleaning composition.

An aerosol composition may contain the above-described cleaning composition and a propellant.

Disclosed, in further embodiments, are cleaning methods which include contacting an article to be cleaned with the cleaning composition.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a non-limiting example of a method of forming an aerosol product in accordance with some embodiments of the present disclosure.

FIG. 2 illustrates a non-limiting example of a portion of an aerosol product in accordance with some embodiments of the present disclosure.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable.

The cleaning composition (e.g., brake cleaning composition) of the present disclosure includes: about 20 wt % to about 90 wt % total of a carbonate ester and optionally a carboxylate ester; and 0 wt % to about 80 wt % total of one or more acetates one or more additional hydrocarbons.

When the carboxylate ester is included, a weight ratio of the carbonate ester to the carboxylate ester may be in a range of about 1:20 to about 20:1, including from about 1:15 to about 15:1, from about 1:10 to about 10:1, from about 1:9 to about 9:1, from about 1:8 to about 8:1, from about 1:7 to about 7:1, from about 1:6 to about 6:1, from about 1:5 to about 5:1, from about 1:4 to about 4:1, from about 1:3 to about 3:1, from about 1:2 to about 2:1, from about 2:3 to about 3:2, from about 3:4 to about 4:3, from about 4:5 to about 5:4, from about 5:6 to about 6:5, from about 6:7 to about 7:6, from about 7:8 to about 8:7, from about 8:9 to about 9:8, and about 1:1.

The carbonate ester may be a dialkyl carbonate.

In particular embodiments, the carbonate ester is dimethyl carbonate.

Alternative amount ranges for the carbonate ester (e.g., dimethyl carbonate) include about 40 wt % to about 80 wt %, about 65 wt % to about 75 wt %, and about 70 wt %.

The carboxylate ester may be included for freezing point depression.

The carboxylate ester is selected from ethyl acetate, n-butyl acetate, isobutyl acetate, and/or phenyl acetate.

The one or more acetates may include at least one alkyl acetate. Non-limiting examples of alkyl acetates include methyl acetate and t-butyl acetate.

The acetate(s) may be included in an amount of 0 wt % to about 40 wt %, including from about 0.1 wt % to about 40 wt %, from about 1 wt % to about 40 wt %, from about 10 wt % to about 40 wt %, and from about 15 wt % to about 25 wt %.

The one or more additional hydrocarbons may include a hydrocarbon of general formula (I):

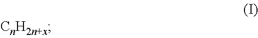

where n is in a range of 5 to 8; and where x is 0 or 2. Combinations of two or more different compounds of this formula are also contemplated. In particular embodiments, n is 6 or 7.

Compounds of formula (I) include, but are not limited to, straight-chain alkanes and cycloalkanes.

In some embodiments, hydrocarbons of general formula (I) include n-pentane (n-C₅H₁₂), isopentane (i-C₅H₁₂), n-hexane (n-C₆H₁₄), isohexane (i-C₆H₁₄), n-heptane (n-C₇H₁₆), isoheptane (i-C₇H₁₆), n-octane (n-C₈H₁₈), and isooctane (i-C₈H₁₈), methyl cyclohexane (C₇H₁₄), and/or cyclohexane (C₆H₁₂).

The compound(s) of general formula (I) may be included in an amount of 0 wt % to about 10 wt %, including from about 0.1 wt % to about 10 wt %, and from about 1 wt % to about 10 wt %.

The brake cleaning composition may further include an aromatic hydrocarbon (e.g., benzene, toluene, xylene). In some embodiments, the cleaning composition further include naphtha (e.g., hydro-treated light naphtha). The naphtha content may be in a range of 0 wt % to about 20 wt %, including from about 5 wt % to about 15 wt % or from about 7 wt % to about 13 wt %.

In particular embodiments, the cleaning composition includes about 20 wt % to about 90 wt % dimethyl carbonate, 0 wt % to about 40 wt % acetate(s), and 0 wt % to 10 wt % of one or more hydrocarbons of general formula (I). For example, the cleaning composition may contain 40 wt % to 80 wt % dimethyl carbonate, 10 wt % to 40 wt % acetate(s), and 0.1 wt % to 10 wt % of one or more hydrocarbons of general formula (I). Alternatively, the compound(s) of formula (I) may be omitted entirely.

Compositions containing about 65 wt % to about 75 wt % dimethyl carbonate and about 15 wt % to about 25 wt % acetate(s) are also contemplated. Optionally, these compositions further contain about 1 wt % to about 10 wt % compound(s) of general formula (I).

The cleaning composition may further include one or more additives (e.g., fragrances, surfactants, corrosion inhibitors, hydrotropes, solubilizing agents, foaming agents, etc.).

The fragrance may be included in an amount of 0 wt % to about 3 wt %, including about 0.01 wt % to about 2 wt % and about 0.05 wt % to about 1 wt %. Non-limiting examples of fragrances include d-limonene, citronella essential oil, eucalyptus essential oil, clove oil, thyme essential oil, lemongrass essential oil, peppermint essential oil, cinnamon essential oil, lavender essential oil, tea tree essential oil, rosemary essential oil, sweet orange essential oil, chamomile essential oil, rose essential oil, hyssop essential oil, clay sage essential oil, ylang ylang essential oil, myrrh essential oil, vetiver essential oil, frankincense essential oil, helychrysum essential oil, chrysanthemum essential oil, grapefruit essential oil, cedarwood essential oil, pine tree essential oil, spearmint essential oil, basil essential oil, melaleuca essential oil, arborvitae essential oil, cassia essential oil, oregano essential oil, agar essential oil, ajwain essential oil, angelica root essential oil, anise essential oil, asafetida essential oil, balsam of Peru essential oil, bay essential oil, bergamot essential oil, black pepper essential oil, bachu essential oil, birch essential oil, camphor essential oil, calamodin essential oil, caraway seed essential oil, calamus essential oil, coconut essential oil, coffee essential oil, coriander oil, costmary essential oil, costus root essential oil, cranberry seed essential oil, cubeb essential oil, cumin seed essential oil, black seed essential oil, cypress essential oil, cypriol essential oil, curry leaf essential oil, davana essential oil, dill essential oil, elecampane essential oil, elemi essential oil, fennel seed essential oil, fenugreek essential oil, fir essential oil, galangal essential oil, galbanum essential oil, garlic essential oil, geranium essential oil, ginger essential oil, goldenrod essential oil, grapefruit essential oil, henna essential oil, helichrysum essential oil, hickory nut essential oil, horseradish essential oil, tansy essential oil, jasmine essential oil, juniper berry essential oil, lemon essential oil, ledum essential oil, lime essential oil, mandarin essential oil, mango essential oils, marjoram essential oil, lemon balm essential oil, moringa essential oil, mugwort essential oil, mustard essential oil, myrtle essential oil, neem essential oil, neroli essential oil, nutmeg essential oil, orris essential oil, palo santo essential oil, parsley essential oil, patchouli essential oil, perilla essential oil, petitgrain essential oil, pineapple essential oil, ravensara essential oil, red cedar essential oil, rosehip essential oil, rosewood essential oil, sandalwood essential oil, sassafras essential oil, savory essential oil, schisandra essential oil, spearmint oil, spruce essential oil, star anise essential oil, tangerine essential oil, tarragon essential oil, tsuga essential oil, turmeric essential oil, valerian essential oil, warionia essential oil, western red cedar essential oil, wintergreen essential oil, yarrow essential oil, amyl acetate, benzaldehyde, and benzyl alcohol. Combinations of two or more of these fragrances are also contemplated.

The surfactant may be a quaternary ammonium surfactant. Amount ranges include 0 wt % to about 5 wt % and about 0.001 wt % to about 1 wt %.

Non-limiting examples of corrosion inhibitors include sodium silicate and potassium silicate. Amount ranges include 0 wt % to about 5 wt % and about 0.001 wt % to about 1 wt %.

Non-limiting examples of hydrotropes include sodium xylene sulfonate, sodium cumene sulfonate, sodium naphthalene sulfonate, potassium xylene sulfonate, potassium cumene sulfonate and potassium napthphtalene sulfonate. Amount ranges include 0 wt % to about 5 wt % and 0.001 wt % to about 1 wt %.

Non-limiting examples of solubilizing agents include sodium alkyl dipropionate, sodium alkyl sulfosuccinate, sodium alkyl betaine, potassium alkyl dipropionate, potassium alkyl sulfosuccinate, and potassium alkyl betaine. Amount ranges include 0 wt % to about 5 wt % and 0.001 wt % to about 1 wt %.

Non-limiting examples of foaming agents include sodium alkyl betaine, sodium alkyl sultaine, sodium alkyl sarcosinate, sodium alkyl sulfonate, sodium alkyl sulfate, potassium alkyl betaine, potassium alkyl sultaine, potassium alkyl sarcosinate, potassium alkyl sulfonate and potassium alkyl sulfate. Amount ranges include 0 wt % to about 5 wt % and 0.001 wt % to about 1 wt %.

Brake cleaner compositions of the present invention may be prepared by mixing the desired components, for example, using a low shear type mixer. The order of addition of the various components has not been shown to affect the resulting brake cleaner composition. Typically and preferably, explosion-proof manufacturing facilities and equipment must be used in mixing and packaging of the brake cleaner compositions.

The cleaning composition optionally further contains water. Non-limiting examples of the amount of water include 0 wt % to about 20 wt % and about 1 wt % to about 15 wt %.

In some embodiments, the cleaning composition has a VOC content of less than 50 wt %, less than 45 wt %, less than 40 wt %, less than 35 wt %, less than 30 wt %, less than 25 wt %, less than 20 wt %, less than 15 wt %, less than 10 wt %, or less than 5 wt %.

The cleaning composition may be free of chlorofluorocarbons.

In some embodiments, the composition does not contain any ketones. Use of acetates, particularly alkyl acetates such as methyl acetate and/or t-butyl acetate, may advantageously in comparison to use of ketones such as acetone, reduce unwanted odors, reduce harm to painted surfaces, evaporate slightly slower to facilitate better cleaning, and/or lower health risk.

The brake cleaning compositions of the present application may be supplied in an aerosol spray can for convenient application. When provided in an aerosol spray can, a propellant is included with the brake cleaning. Suitable propellants include, for example, nitrogen, carbon dioxide, argon, compressed air, propane, isobutane, normal butane, and mixtures thereof. Typically, liquid aerosol propellants such as propane, butane, and isobutane can be added to a brake cleaning composition in an amount ranging from about 1 wt % to about 10 wt % of the composition. When the aerosol propellant is itself classified as a VOC (e.g., propane, butane, isobutane) the quantity of hydrocarbon solvent of formula (I) is preferably reduced in order to provide a composition having less than 10 wt % of total VOC. When gases such as argon, nitrogen, carbon dioxide, and compressed air are used as the propellant, the gas propellant may be present in an amount ranging from about 2 wt % to about 10 wt %.

In some embodiments, the aerosol composition has a VOC content of less than 50 wt %, less than 45 wt %, less than 40 wt %, less than 35 wt %, less than 30 wt %, less than 25 wt %, less than 20 wt %, less than 15 wt %, less than 10 wt %, or less than 5 wt %.

The aerosol composition may be free of chlorofluorocarbons.

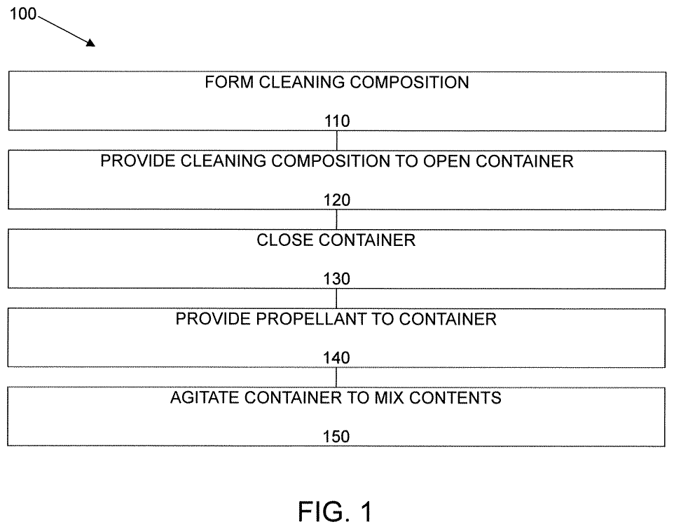

FIG. 1 illustrates a first non-limiting method 100 of producing an aerosol product in accordance with some embodiments of the present disclosure. The method 100 includes forming a cleaning composition 110; providing the cleaning composition to a container 120; closing the container 130; providing a propellant to the container via a valve 140; and mixing the contents 150. In some embodiments, the valve is included in a closure applied during the closing 130.

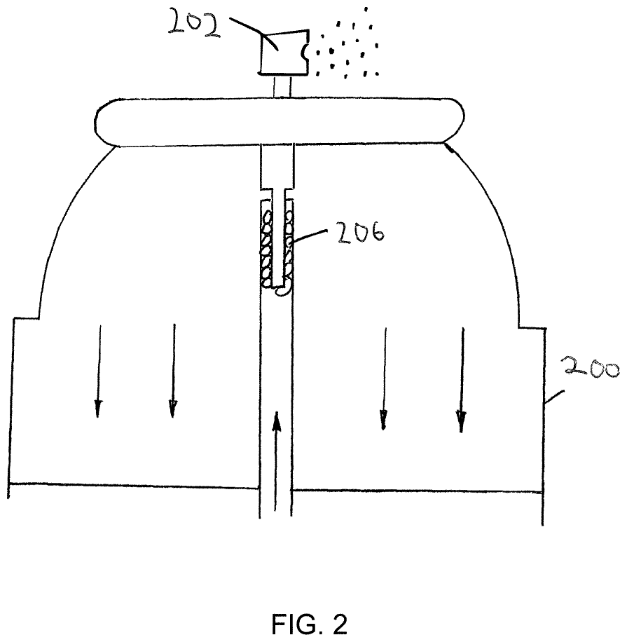

FIG. 2 shows a portion of a known aerosol spray container 200 that receives the cleaning composition described above. More specifically, known aerosol valve technology uses an actuator/spray nozzle 202 which, when depressed, opens a spring-loaded valve allowing a liquid material to exit the pressurized container or can 200 through the actuator/spray nozzle. The valve returns to a closed position when the actuator/spray nozzle 202 is released due to the returning force imposed by a spring 206. After actuating the valve and spraying the cleaning composition through the actuator/spray nozzle 202, and before long term storage of the partially empty container, the container 200 may be turned upside down and the actuator/spray nozzle depressed to allow gas propellant to evacuate or clean the actuator/spray nozzle and the valve assembly. A seal or gasket that a plunger of the valve rests against may prevent propellant and cleaning composition from inadvertently escaping the container 200.

The composition may also be provided in a product that is not an aerosol spray. For example, the composition may be provided as a liquid in a non-spray container or a non-aerosol spray product such as a pump spray product.

The cleaning compositions of the present disclosure may be utilized to clean brake systems or individual components thereof. Non-limiting examples of such components include drums, rotors, calipers, brake pads, and brake shoes.

The brake cleaning composition dissolves oil quickly and wets out particulate contamination all while being safe on painted surfaces such as calipers.

The cleaning compositions may be directly spray applied to components to be cleaned. This may facilitate the compositions reaching difficult-to-reach surfaces. Wetting the surfaces may loosen or lead to contaminants falling off. It is also possible to subsequently contact the surface (e.g., with water from a hose) to flush away contaminants. The residence time of the cleaning composition on the surface prior to flushing away may be varied depending on the contaminant composition and/or amount. Additionally, multiple applications of the cleaning compositions may be utilized. It is also contemplated that the compositions may be applied to a carrier component (e.g., a rag) and used to wipe a surface to be cleaned.

A particular cleaning method includes providing a component to be cleaned and applying a cleaning composition containing about 20 wt % to about 90 wt % dimethyl carbonate, one or more acetates (e.g., alkyl acetates such as methyl acetate and/or t-butyl acetate, and optionally one or more additional hydrocarbons. The one or more additional hydrocarbons be 0 wt % to about 10 wt % of one or more compounds of general formula (I). Cleaning after the cleaning composition is applied may be active or passive. In active cleaning, the surface being cleaned may be wiped and/or subsequently sprayed. In passive cleaning, the mere application of the cleaning composition is sufficient to break down and removed contaminants. In some embodiments, the cleaning composition is applied via aerosol spray. The aerosol spray contains the cleaning composition and a propellant.

This written description uses examples to describe the disclosure, including the best mode, and also to enable any person skilled in the art to make and use the disclosure. Other examples that occur to those skilled in the art are intended to be within the scope of the present disclosure if they have structural elements that do not differ from the same concept, or if they include equivalent structural elements with insubstantial differences. It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A cleaning composition comprising:
about 20 wt % to about 90 wt % dimethyl carbonate;
0 wt % to about 40 wt % acetate(s); and
0 wt % to about 10 wt % of one or more hydrocarbons of general formula (I):
CₙH₂ₙ₊ₓ (I);
wherein n is in a range of 5 to 8; and
wherein x is 0 or 2.

2. The cleaning composition of claim 1, comprising:
about 40 wt % to about 80 wt % dimethyl carbonate;
about 10 wt % to about 40 wt % acetate(s); and
about 0.1 wt % to about 10 wt % of one or more hydrocarbons of general formula (I).

3. The cleaning composition of claim 1, comprising:
about 65 wt % to about 75 wt % dimethyl carbonate;
about 15 wt % to about 25 wt % acetate(s); and
about 1 wt % to about 10 wt % of one or more hydrocarbons of general formula (I).

4. The cleaning composition of claim 1, wherein x is 0.

5. The cleaning composition of claim 1, wherein x is 2.

6. An aerosol composition comprising:
the cleaning composition of claim 1; and
a propellant.

7. The aerosol composition of claim 6, wherein the propellant is selected from the group consisting of carbon dioxide, nitrogen, air, n-butane, isobutane, and propane.

8. An aerosol spray product comprising:
a container defining an interior volume;
the aerosol composition of claim 6 within the interior volume; and
a nozzle for spraying the aerosol composition.

9. A cleaning composition comprising:
about 20 wt % to about 90 wt % total of a carbonate ester and optionally a carboxylate ester; and
0 wt % to about 80 wt % total of one or more acetates and one or more additional hydrocarbons.

10. The cleaning composition of claim 9, wherein the carbonate ester comprises a dialkyl carbonate.

11. The cleaning composition of claim 9, wherein the carbonate ester comprises dimethyl carbonate.

12. The cleaning composition of claim 9, wherein the one or more additional hydrocarbons comprises an alkane.

13. The cleaning composition of claim 9, wherein the one or more acetates comprises methyl acetate and/or t-butyl acetate.

14. The cleaning composition of claim 13, wherein the methyl acetate and/or t-butyl acetate is/are present in an amount of about 0 wt % to about 40 wt % of the cleaning composition.

15. The cleaning composition of claim 13, wherein the methyl acetate and/or t-butyl acetate is/are present in an amount of about 10 wt % to about 40 wt % of the cleaning composition.

16. The cleaning composition of claim 13, wherein the methyl acetate and/or t-butyl acetate is/are present in an amount of about 15 wt % to about 25 wt % of the brake cleaning composition.

17. The cleaning composition of claim 9, wherein the alkane comprises one or more compounds of the formula C₂H₂ₙ₊ₓ, wherein n is from 5 to 8 and x is 0 or 2.

18. The cleaning composition of claim 9, wherein the alkane is present in an amount of 0 wt % to about 10 wt % of the cleaning composition.

19. The cleaning composition of claim 9, wherein the alkane is present in an amount of about 1 wt % to about 10 wt % of the cleaning composition.

20. An aerosol composition comprising:
the cleaning composition of claim 9; and
a propellant.
